(19) United States
(12) Patent Application Publication
(10) Pub. No.: US 2015/0015509 A1
(43) Pub. Date: Jan. 15, 2015

(54) METHOD AND SYSTEM OF OBTAINING AFFECTIVE STATE FROM TOUCH SCREEN DISPLAY INTERACTIONS

(71) Applicants: David H. Shanabrook, Pelham, MA (US); Ivon Arroyo, Amherst, MA (US); Beverley P. Woolf, Amherst, MA (US)

(72) Inventors: David H. Shanabrook, Pelham, MA (US); Ivon Arroyo, Amherst, MA (US); Beverley P. Woolf, Amherst, MA (US)

(21) Appl. No.: 14/325,793

(22) Filed: Jul. 8, 2014

Related U.S. Application Data
(60) Provisional application No. 61/845,156, filed on Jul. 11, 2013.

(51) Int. Cl. G06F 3/041; G06F 3/0488; G06N 5/04

(52) U.S. Cl. CPC G06F 3/0414; G06N 5/04; G06F 3/04883
USPC 345/173

(57) ABSTRACT

Methods and systems for obtaining affective state from physical data related to touch in a computing device with a touch screen display. The method includes obtaining, from the touchscreen display in the computing device, touch data related to physical characteristics of the touch input, the touch data being collected during computing exercises that impact affective phenomena, obtaining, from performance of the computing exercises on the computing device with a touch screen display, affective phenomena data, and determining a predictive relationship between the affective phenomena data and the touch data. In one instance, the touch data related to physical characteristics of the touch input is obtained from raw touch data. The system performs the method.

### CROSS REFERENCE TO RELATED APPLICATIONS

This application claims priority to and benefit of U.S. Provisional Application No. 61/845,156, entitled OBTAINING AFFECTIVE STATE FROM TOUCH SCREEN DISPLAY INTERACTIONS, filed on Jul. 11, 2013, which is incorporated by reference herein in its entirety and for all purposes.

### STATEMENT REGARDING FEDERALLY SPONSORED RESEARCH OR DEVELOPMENT

This invention was made partially with U.S. government support from the National Science Foundation (NSF) under grant No. 0705554. The government has certain rights in the invention.

### BACKGROUND

These teachings relate generally to obtaining affective state from such interactions with a touch screen display.

In a human tutoring situation, an experienced teacher attempts to be aware of a students' affective state and to use this knowledge to adjust his/her teaching. For the student who requires a challenge, problem difficulty can be increased. And for the frustrated student, assistance can be provided. Research has shown that affect detection and interventions in the intelligent tutoring environment can also improve learning effectiveness. But the effectiveness of any intervention based on students' learning state is dependent on the ability to accurately access that state, whether by the human or the computer. In an intelligent tutoring system, real time affect detection is typically attempted either by analyzing student interaction with the system or with sensors. Sensors have the advantage over content specific predictors as they are usually context free; the predictive model is applicable across applications and content. Hardware sensors are used to detect physical actions of the user; camera, chair and mouse sensors can detect facial expressions, posture changes, and hand pressure. Physiological sensors detect internal changes such as heart rate and skin resistance. While sensors have been successfully correlated to student affective state, they are also hard to deploy in real-life situations; they require invasive non-standard hardware and software.

The introduction of computer tablets has produced a new, potentially unique, source of sensory data: touch movements. Tablets, particularly the Apple iPad, are rapidly replacing the traditional PC especially in the education environment. The tablet predominately uses touch interaction; one or more fingers control the interface and provide input by their location and movement directionality. It replaces the mouse and keyboard for control, and the pen in drawing applications. Research has shown differences in cognitive load between keyboard and handwriting input, with increased load for the former method. While touch writing is similar to handwriting, it also feels very different, and cognitive differences exist between it and these other input modalities.

Devices with touch screen displays are being planned for wearable devices and the possibility of having a touch screen display made out of fibers has been discussed. Touch writing is likely to be ubiquitous.

There is a need for methods and systems for obtaining affective state from such interactions in a computing device with a touch screen display.

### BRIEF SUMMARY

Methods and systems for obtaining affective state from physical data related to touch in a computing device with a touch screen display are disclosed. In one or more embodiments, the method of these teachings includes obtaining, from the touchscreen display in the computing device, touch data related to physical characteristics of the touch input, the touch data being collected during computing exercises that impact affective phenomena, obtaining, from performance of the computing exercises on the computing device with a touch screen display, affective phenomena data, and determining a predictive relationship between the affective phenomena data and the touch data. In one instance, the touch data related to physical characteristics of the touch input is obtained from raw touch data.

In one or more embodiments, the system of these teachings includes a touchscreen display, one or more processors and computer usable media having computer readable code embodied therein, the computer readable code configured to be executed by the one or more processors in order to perform the method of these teachings.

In other embodiments, the method of these teachings includes obtaining physical data from predetermined computing exercises on a tablet and obtaining an indication of affective phenomena from a predetermined predictive relationship between the affective phenomena data and the physical data.

In one instance, the computer readable code includes instructions that cause the one or more processors to display a user interface object. In one instance, touch input to the user interface object causes the initiation of the method of these teachings.

Other embodiments of the method of these teachings, the system of these teachings and computer usable media of these teachings are also disclosed.

These teachings elucidate how the touch interaction can be used as a sensor input for affect detection. The advantages over other sensors as a predictor are readily apparent: the tablet platforms are inexpensive and becoming widespread (including smart phones and wearable devices), no additional hardware is required, data collection is straightforward as it is an integral part of a touch input device, and lastly is non-invasive as again being integral to the input device

For a better understanding of the present teachings, together with other and further needs thereof, reference is made to the accompanying drawings and detailed description and its scope will be pointed out in the appended claims.

### BRIEF DESCRIPTION OF THE DRAWINGS

FIG. 1 shows an exemplary embodiment of these teachings;

FIG. 2 shows a tablet display for solution of a problem in an exemplary embodiment and a corresponding acceleration touch data;

FIG. 3a shows a graphical display of acceleration data for problems in the exemplary embodiment;

FIG. 3b shows a graphical display of statistical test results for the data of FIG. 3a;

FIG. 4 shows the touch screen display during operation of the application (which performs an embodiment of the method of these teachings) initiated after input to the user interface object;

FIG. 5 shows a block diagram of an embodiment of the method of these teachings;

FIGS. 6a, 6b show implementation of the predictive relationship between the affective phenomena and the touch data;

FIG. 7 shows a schematic representation of the collection of the touch data;

FIG. 8 shows a flowchart of the use of an embodiment of these teachings; and

FIG. 9 shows a block diagram of an embodiment of the system of these teachings.

### DETAILED DESCRIPTION

The following detailed description presents the currently contemplated modes of carrying out the invention. The description is not to be taken in a limiting sense, but is made merely for the purpose of illustrating the general principles of the invention, since the scope of the invention is best defined by the appended claims.

“Affective phenomena,” as used herein, include emotions, feelings, moods, attitudes, affective styles, and temperament.

“Tablet,” as used herein, refers to any computing device with a touch screen display. (Computing devices include wearable computer devices and smart phones.)

Methods and systems for obtaining affective state from physical data related to touch in a tablet are disclosed. In one or more embodiments, the method of these teachings includes obtaining, from the touchscreen display in the computing device, touch data related to physical characteristics of the touch input, the touch data being collected during computing exercises that impact affective phenomena, obtaining, from performance of the computing exercises on the computing device with a touch screen display, affective phenomena data, and determining a predictive relationship between the affective phenomena data and the touch data. In one instance, the touch data related to physical characteristics of the touch input is obtained from raw touch data.

In other embodiments, the method of these teachings includes obtaining physical data from predetermined computing exercises on a tablet and obtaining an indication of affective phenomena from a predetermined predictive relationship between the affective phenomena data and the physical data.

In one or more embodiments, the system of these teachings includes a touchscreen display, one or more processors and computer usable media having computer readable code embodied therein, the computer readable code configured to be executed by the one or more processors in order to perform the method of these teachings.

In some embodiments of the system, the computer readable code, when executed by the one or more processors, causes the one or more processors to obtain, from the touch screen display in the computing device, touch data related to physical characteristics of the touch input, the touch data being collected during computing exercises that impact affective phenomena, obtain, from performance of the computing exercises on the computing device with a touch screen display, affective phenomena data, and determine a predictive relationship between the affective phenomena data and the touch data.

In other embodiments of the system, the computer readable code, when executed by the one or more processors, causes the one or more processors to obtain physical data from predetermined computing exercises on a tablet and obtain an estimate of affective phenomena from a predetermined predictive relationship between the affective phenomena data and the physical data.

In one instance, the computer readable code includes instructions that cause the one or more processors to display a user interface object. In one instance, touch input to the user interface object causes the initiation of the method of these teachings.

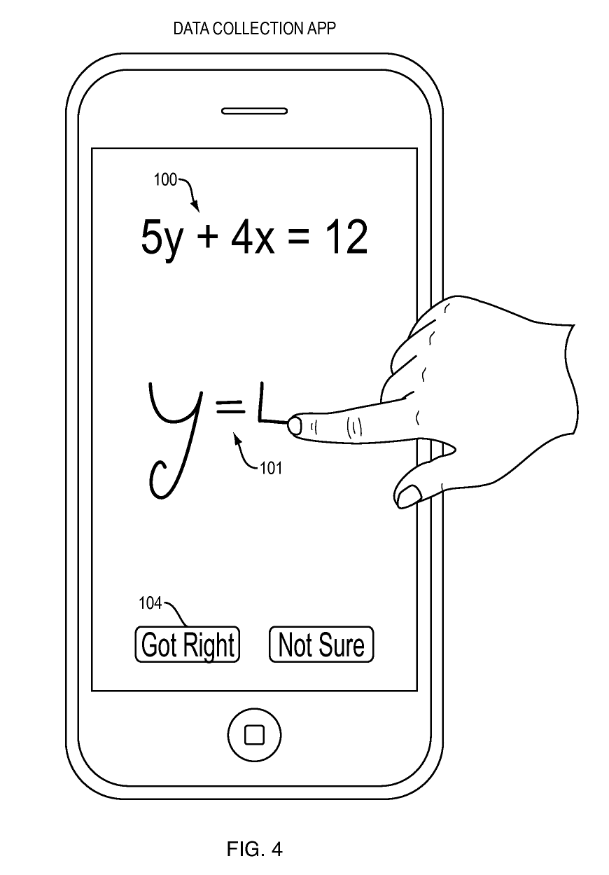

FIG. 4 shows the touch screen display during operation of the application (which performs an embodiment of the method of these teachings) initiated after input to the user interface object. Referring to FIG. 4, in the embodiment shown therein, an example of the collection of data, corresponding to the exemplary embodiment shown hereinbelow, is illustrated. Referring again to FIG. 4, in the exemplary embodiment shown therein, the computing exercise 100, in the exemplary embodiment a mathematical problem, is presented to the user. In the space of the tablet below the computing exercise 100, the user performs the computing exercise generating touch data 101. When the tablet and the computing exercise 100 are being used to generate the predictive relationship, action buttons in the tablet are used to obtain a user response 104 from which the affective phenomena data are obtained.

The collected data from touch included point position, stroke start position, end position and intermediate points. The data at each point includes the x, y coordinates and the positioning of the tablet in space x, y, z. The latter data describes tablet movement which is used to simulate touch pressure. As the data is supplied by the tablet system software, at the present time no additional raw data is available.

Derived data, the direct transformations of this raw data included stroke distance, touch pressure and stroke velocity. Statistically significant results were achieved with this data, however, increased accuracy and more refined affective state detection will likely be achieved when more sophisticated statistical methods are applied. The additional derived measures include variation stroke length, variation in stroke speed (acceleration), change in stroke acceleration (bursting), and stroke frequency, time between strokes.

One exemplary embodiment demonstrates a method of predicting student effort level using touch data. It should be noted that these teachings are not limited to only the exemplary embodiment. Other embodiments are within the scope of these teachings. A simple iPad ‘app’ has been implemented to present problems and record solution input; providing a controlled environment for studying touch as a predictor of affective state. Student activities are used as inputs to models that predict student affective state and thus support tutor interventions.

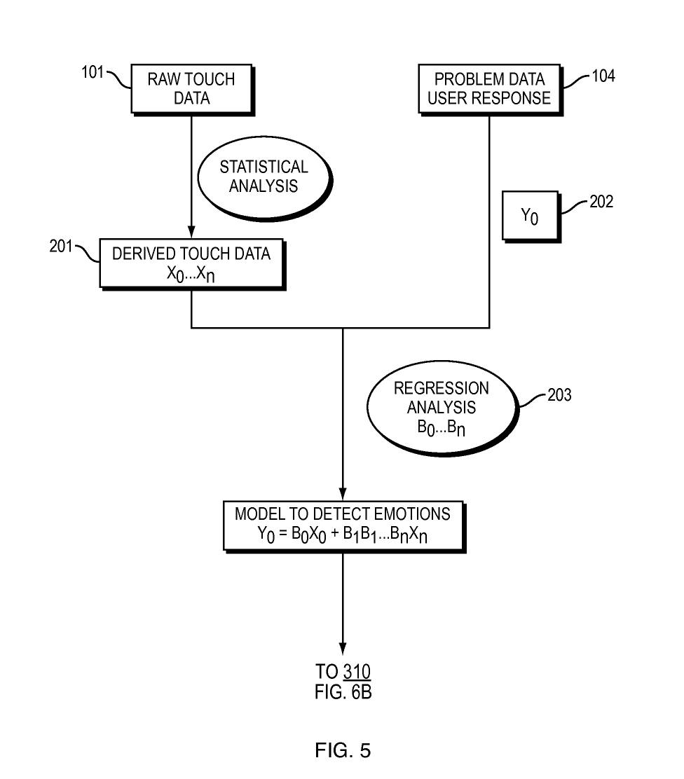

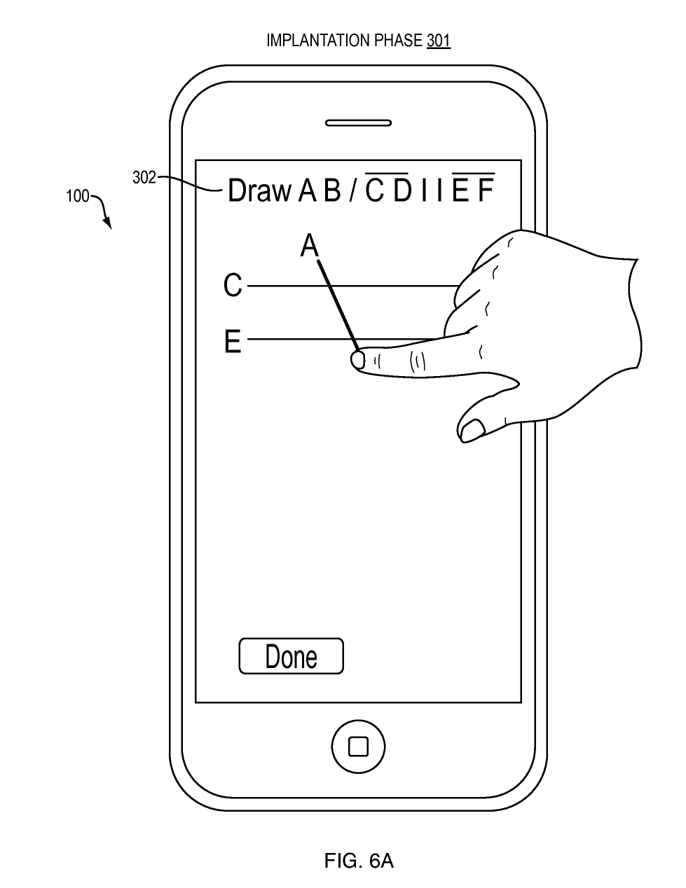

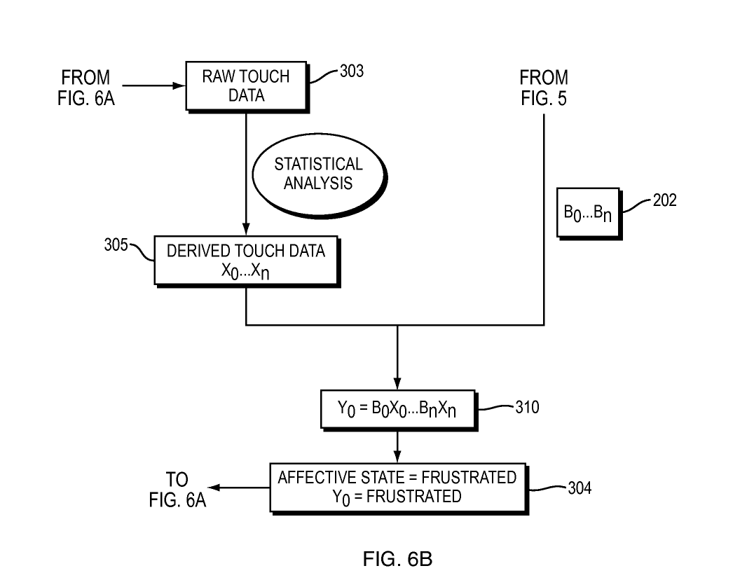

FIG. 5 shows a block diagram of an embodiment of the method of these teachings. Referring to FIG. 5, raw touch data 101 is obtained while the user is performing the computing exercise. Derived touch data 201 is obtained from the raw touch data 101. Affective phenomena data 202 is obtained from the user response 104. Using statistical techniques, such as regression analysis, coefficients 203 for a predictive relationship are obtained.

The statistical methods predominately relied upon descriptive statistics and mean variation using Anova tests. Analysis using regression analysis and bayesian analysis will provided a more accurate model. The regression model uses the derived data as independent variables (IVs) and the affective state as the dependent variable (DV), in the same manner as the current analysis. While the current models rely on single predictors, a regression model will provide more accurate result by combining the independent variables in a single model with each correlating variable decreasing the model error.

The regression equation:

y=αβ₁X₁+β₂X_{2 . . . +ε}

where the DV y is initially triggered in the testing, the IVs
X_{1, X}₂ . . . the logged and derived data, where the Beta terms β₁, β₂ . . . describe the model and allow DV estimation.

The DV describes affective states boredom, high engagement and frustration. Changing to study conditions by triggering other affective states allows the possibility of predicting a more wider range, including disengagement, excitement, off task behavior, etc. The affective states are only limited by those which are present when a person is working on a computing device.

Sequence based motif discovery is an alternative method of finding predictive patterns which is applicable to this work. This methodology categorizes the logged IVs by binning these continuous variables in discreet patterns. Then a “fuzzy” algorithm is used to detect patterns in the variables. The motif discovery algorithm uses a random selection of variable selection within a fixed pattern length to allow a degree of controlled pattern variation. See Shanabrook, D., Cooper, Woolf, B., and Arroyo, I. (2010). Identifying High-Level Student Behavior Using Sequence-based Motif Discovery. Proceedings of EDM, 2010, incorporated by reference herein in its entirety and for all purposes.

FIGS. 6a, 6b show implementation of the predictive relationship between the affective phenomena and the touch data. FIG. 6a shows the application operating in the computing device (tablet). Referring to FIG. 6a, in the embodiment 301 shown there in, a computing exercise 302 is presented to the user. In the region of the tablet below the computing exercise 302, the user performs the computing exercise generating touch data.

FIG. 6b shows a block diagram of the operation and the resulting predicted affective phenomena. Referring to FIG. 6b, in the embodiment shown there in, raw touch data 303 is obtained from the user performing the computing exercise 302. Derived touch data 305 is obtained from the raw touch data 303. The derived touch data 305 is used in the predetermined predictive relationship 310 to obtain an estimate of affective phenomena 304.

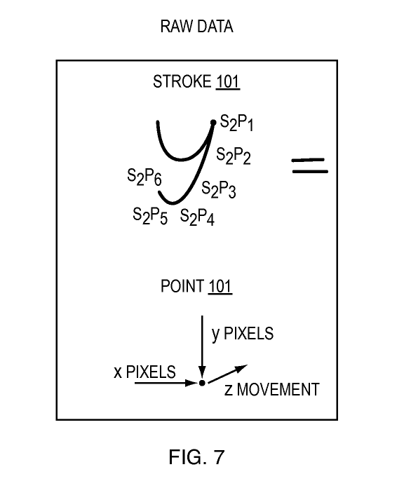

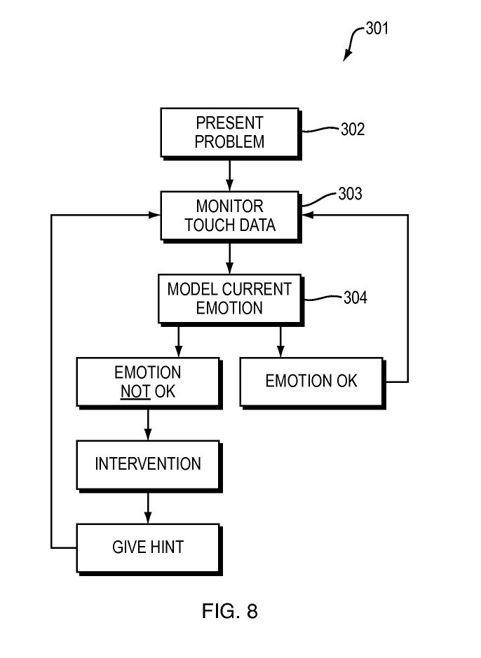

FIG. 7 shows a schematic representation of the collection of the touch data 101. FIG. 8 shows a flowchart of the use of an embodiment 301 of these teachings. Referring to FIG. 8, in the embodiment 301 shown therein, a computing exercise 302, where a predictive relationship between the affective phenomena data and touch data has been seriously obtained for that computing exercise, is presented to the user. As the user performs the computing exercise using the “tablet,” touch data is monitored 303. From the touch data, using the predictive relationship, estimate of affective phenomena data are obtained 304. Based on the estimate of affective phenomena data, it is decided whether to continue monitoring the touch data or, in the exemplary embodiment of a mathematical exercises, it is decided whether to intervene and provide a hint (other interventions correspond to other exemplary embodiments and, in some other exemplary embodiments, other responses to affective phenomena data are within the scope of these teachings.

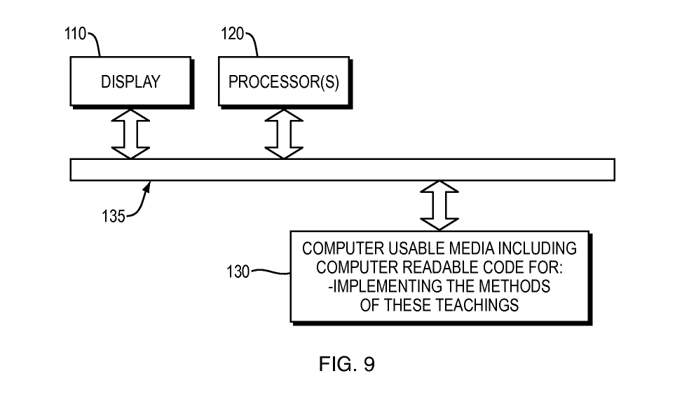

FIG. 9 shows a block diagram of an embodiment of the system of these teachings. Referring to FIG. 9, in the embodiment shown there in, one or more processors 120, a display 110 and computer usable media 130 are operatively connected by a connection component 135. The computer usable media 130 has computer readable code embodied therein, so that the computer readable code, when executed by the one or more processors 120, causes the processors 120 to implement the method of these teachings.

In order to further elucidate these teachings an exemplary embodiment is presented herein below. It should be noted that these teachings are not limited to only the exemplary embodiment. Other embodiments are within the scope of these teachings.

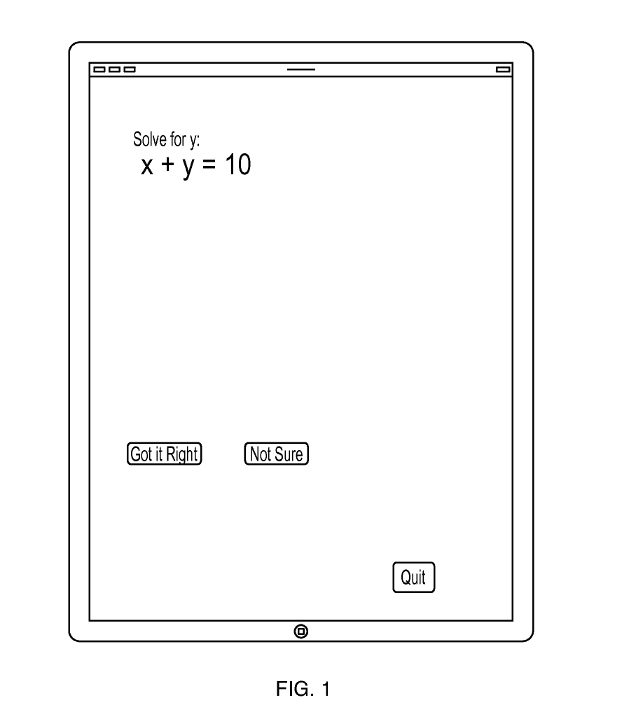

The touchMath app is an environment that supports detection of student effort through touch. It presents mathematics problems, enables and records the student drawings of the solution, then uploads the solution and touch data to a server. Running on the iPad tablet, touchMath sequentially loads the images, math problems, and instructs students to solve the problem (FIG. 1.). Below the mathematics problem is a drawing space where students use touch to work on the problem and deliver answers. The student is instructed to ‘show all work’ as the writing provides the data for affective state detection. Below the working spaced are three action buttons; ‘Got it right!’, ‘Not sure?’ or ‘Quit.’ In another embodiment, there is a slider which the student can use to self-report the perceived problem difficulty, labeled “too easy” to “too hard.” The slider allows the student to choose along a continuous scale, thus avoiding the influence of discreet categories. By compelling the student to self-report the perceived correctness, it is possible to differentiate from actual correctness. The problems are loaded from the server in sequential order until the last problem is completed. New problems can be quickly ‘authored’ by simply creating an image file, e.g. using a graphics program, hand drawing and scanning, copying from the interact, then uploading the images to the server. This ease of authoring allows rapid and flexible problem creation.

Implementation

For each problem the app logs the all touch movements; including strokes, uninterrupted touch movements and the points within each stroke. Points are defined by timestamp and x, y, z coordinates, with z the movement of the tablet due to touch pressure (Table 1). The iPad surface is not touch pressure sensitive, however, it contains a hardware accelerometer that detects positive and negative movements along the z axis. The hardware is sensitive enough to roughly replicate the functionality of a pressure sensitive tablet surface 1.

When the student touches the tablet a new stroke recording starts, and continues until the finger is lifted. The stroke time is logged along with the points within the stroke2. The series of strokes are logged for each problem solution. When the student completes the problem the strokes log is retained with the problem level information. When the student completes the session, all problem data is retained with the student level information, and the complete data file is uploaded to the server for later analysis. From this data we can derive: stroke time, stroke distance, and stroke velocity.

TABLE 1
Touch Data

| event level | logged data | derived data |
|---|---|---|
| student | studentId, problemId, | timeElapsed, |
| | startTime, stopTime | numReportedCorrect, |
| | | numActuallyCorrect |
| problems | strokes, problemId, | timeElapsed, numStrokes |
| | solutionImage, | |
| | reportCorrect, startTime, | |
| | stopTime | |
| strokes | points, startTime, stopTime | timeElapsed, distance, |
| points | x, y, z accel, timestamp | velocity |

Testing Environment

Testing was performed on individual subjects in a variety of settings. This exemplary embodiment is detailed in teens of one subject. The subject was: a male, 12 year old, 7th grade middle school student. The four chosen problems were basic algebra equation simplification problems, a subject chosen as it was similar to the students current math curriculum. The problems were intended to increase in difficulty from easy to beyond ability:

prob0: x+y=10, prob1:3x+y=5, prob2:³₅x+⁷₈y=4, prob3: 3=34y²−y−5.3x³

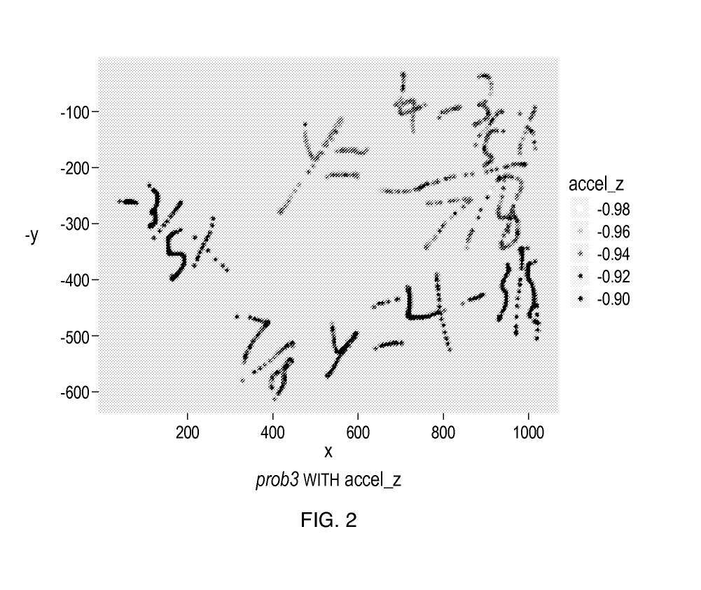

Knowing this students level of algebra knowledge we categorized prob0, prob1 as low effort, prob2 as high effort, prob3 as beyond current ability. The student performed as expected with the first three problems, solving the first two with little difficulty, and the third, prob2, with greater effort. The student's approach to prob3 was to solve for y, but in error, leaving the y² variable on the right side of the equation. At the students level of knowledge this was appropriate, as he solved for y as summing it was correct to include y2 in the solution, and he indicated this by selecting ‘Got it right!’. (In another embodiment, the subject indicated this by selecting the left end of the slider scale.) Therefore, this solution is categorized with the first two as requiring low effort. Accelerometer data from performing the solution to prob3 is shown in FIG. 2.

Findings

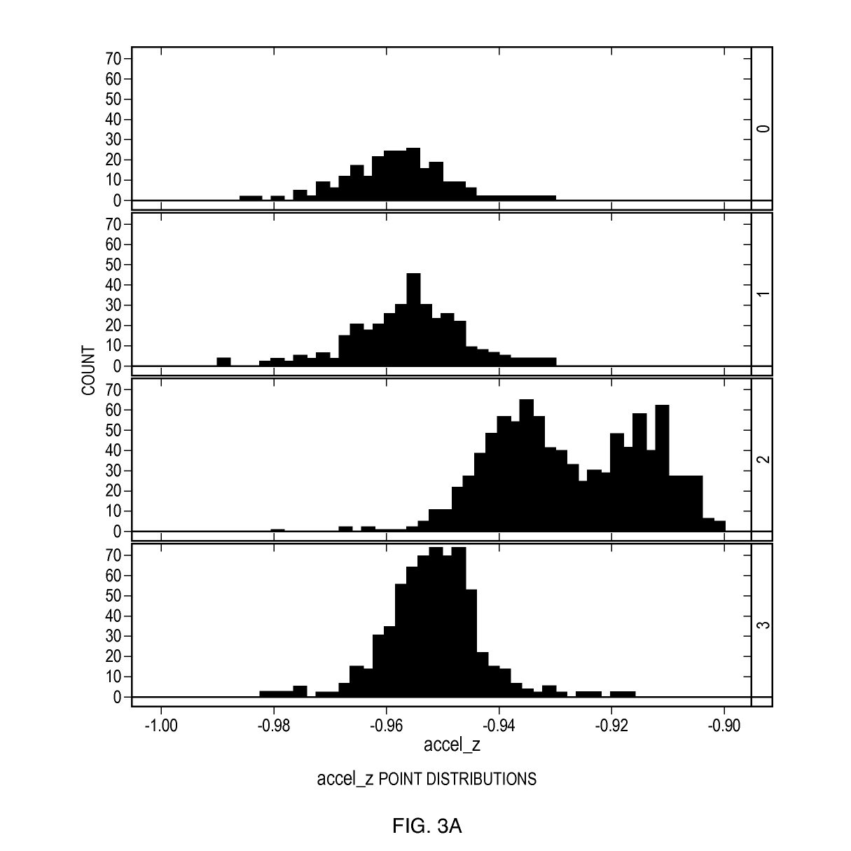

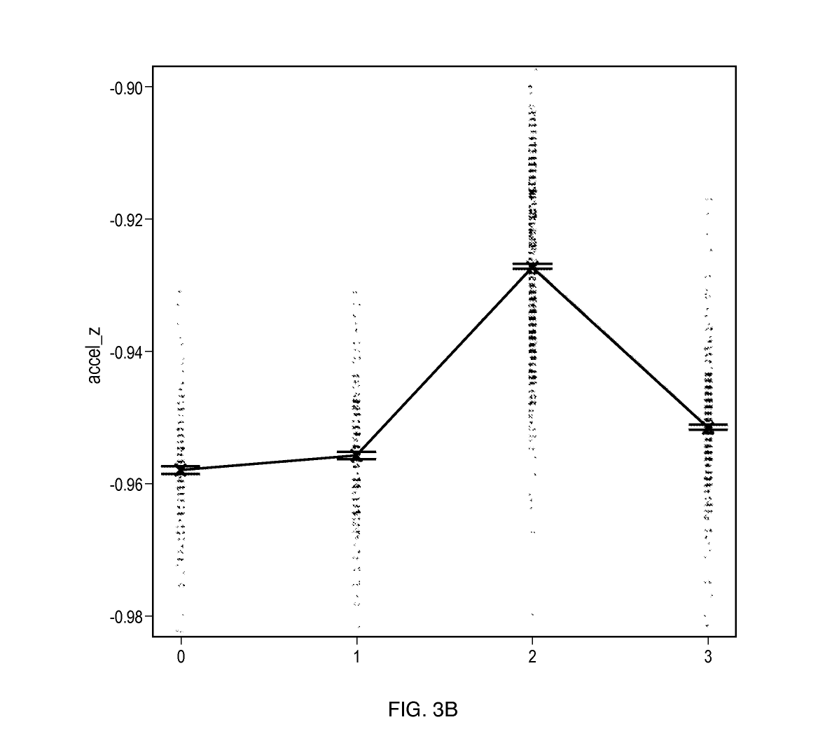

Initial visual analysis of the logged data and derived data (Table 1), was performed comparing these metrics across problems. The plots indicated only aced z differs significantly between low effort prob0, prob1, prob3 and high effort prob2 (FIG. 3a); with prob2 plot having more variation and a bimodal distribution. ANOVA results indicate significance for accel z˜problem (p-value 0). And pairwise t-test using Bonferroni adjustment confirmed a significant difference only between the low and high effort problems (FIG. 3b) with overlap of SEM intervals except in prob2; showing touch pressure as defined by movement on the z axis as a predictor of level of effort in problem solving,

It should be noted that the present teachings are not limited to only the exemplary embodiment. In other embodiments, the computing exercises (problems) are designed to induce other affective phenomena, for example, but not limited to, boredom, anger, “flow” (working at an optimal level of ability), and the affective phenomena data is obtained. For example, in another exemplary embodiment, the computing exercises are designed to induce frustration in the user. A predictive relationship is then obtained between the affective phenomena data and the touch data. The predictive relationship can be used to predict the affective phenomena data from the touch data. By designing other computing exercises, the present teachings can be used to obtain predictive relationships for affective phenomena data other than that described in the exemplary embodiment.

It should also be noted that the word “tablet” is used as defined, that is a tablet is any computing device that has a touch screen display, and the word applies to other computing devices such as wearable computing devices. The computing exercise used to obtain the affective Phenomena data can be a variety of computing exercises including, but not limited to, searches in the Internet or communication web. The affective phenomena data also has a broad range of applications and instantiations.

For the purposes of describing and defining the present teachings, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Although these teachings has been described with respect to various embodiments, it should be realized these teachings are also capable of a wide variety of further and other embodiments within the spirit and scope of the appended claims.

What is claimed is:

1. A method for obtaining affective state from physical data related to touch in a tablet, the method comprising:
obtaining, from a touch screen display in a computing device, touch data related to physical characteristics of touch input; the touch data being collected during computing exercises that impact affective phenomena;
obtaining, from performance of the computing exercises on the computing device with a touch screen display, affective phenomena data; and
determining a predictive relationship between the affective phenomena data and the touch data.

2. The method of claim 1, wherein the touch data related to physical characteristics of the touch input is obtained from raw touch data.

3. The method of claim 1, wherein the computing exercise is problem solving and the affective phenomena data represents level of effort.

4. A method for obtaining affective state from physical data related to touch in a tablet, the method comprising:
obtaining physical data from predetermined computing exercises on a tablet; and
obtaining an estimate of affective phenomena from a predetermined predictive relationship between affective phenomena data and the physical data.

5. The method of claim 4, wherein the physical data is related to physical characteristics of touch input; the physical data being obtained from raw touch data.

6. The method of claim 4, wherein the computing exercise is problem solving and the affective phenomena data represents level of effort.

7. The method of claim 6 further comprising using the affective phenomena data in a learning environment for deciding interventions.

8. A system for obtaining affective state from physical data related to touch in a tablet, the system comprising:
a touch screen display;
one or more processors; and
non-transitory computer usable media having computer readable code embodied therein, the computer readable code, when executed by the one or more processors, causes the one or more processors to:
obtain, from the touch screen display, touch data related to physical characteristics of touch input; the touch data being collected during computing exercises that impact affective phenomena;
obtain, from performance of the computing exercises on the touch screen display, affective phenomena data; and
determine a predictive relationship between the affective phenomena data and the touch data.

9. The system of claim 8, wherein the computer readable code includes instructions that cause the one or more processors to display a user interface object.

10. The system of claim 9, wherein touch input to the user interface object causes initiation of execution of the computer readable code.

11. The system of claim 8, wherein the touch data related to physical characteristics of the touch input is obtained from raw touch data.

12. The system of claim 8, wherein the computing exercise is problem solving and the affective phenomena data represents level of effort.

13. A system for obtaining affective state from physical data related to touch in a tablet, the system comprising:
a touchscreen display;
one or more processors; and
non-transitory computer usable media having computer readable code embodied therein, the computer readable code, when executed by the one or more processors, causes the one or more processors to:
obtain physical data from predetermined computing exercises on a tablet; and
obtain an estimate of affective phenomena from a predetermined predictive relationship between affective phenomena data and the physical data.

14. The system of claim 13, Wherein the computer readable code includes instructions that cause the one or more processors to display a user interface object.

15. The system of claim 14, wherein touch input to the user interface object causes initiation of execution of the computer readable code.

16. The system of claim 13, wherein the touch data related to physical characteristics of touch input is obtained from raw touch data.

17. The system of claim 13, wherein the computing exercise is problem solving and the affective phenomena data represents level of effort.
